(19) United States
(12) Patent Application Publication
(10) Pub. No.: US 2003/0213702 A1
(43) Pub. Date: Nov. 20, 2003

(54) Waste disposal apparatus and method

(75) Inventor: Lance Mann, Cleveland (AU)

Correspondence Address: COOK, ALEX, MCFARRON, MANZO,, CUMMINGS & MEHLER, LTD., Suite 2850, 200 West Adams St., Chicago, IL, 60606, US

(73) Assignee: Zamview Pty Ltd. ACN 010 805 731

(21) Appl. No.: 10/233,040

(22) Filed: Aug. 30, 2002

(30) Foreign Application Priority Data
May 16, 2002 (AU) 40673/02

(51) Int. Cl. C02F 1/461; C25D 17/00

(52) U.S. Cl. 205/556; 205/701; 205/742; 204/242; 204/275.1

(57) ABSTRACT

There is provided waste treatment apparatus generally indicated as 10 and comprising a moulded plastic tank portion 11 forming an electrolysis chamber 13 and a holding chamber 14 separated by a bulkhead 15. The tanks are mutually closed at their tops by tank top 16 which closes over the bulkhead 15 to form substantially isolated spaces in the respective tanks. The electrolysis chamber 13 receives waste entrained in sea water from a macerating marine toilet (not shown) via a waste inlet 17 disposed at the upper portion of the electrolysis chamber 13. A displacement tube 20 picks up waste from the bottom of the electrolysis chamber 13 and discharges to the top of the holding chamber 14. A series of ruthenium/iridium oxide coated titanium electrode pairs 21 are disposed generally vertically to encourage vertical column circulation in the electrolysis chamber by virtue of the action of outgassed electrolysis products. A float transducer 23 provides holding chamber level data to the controller 22 which controls the operation of a discharge pump 26 adapted to selectively empty the holding chamber 14.

### BACKGROUND OF THE INVENTION

This invention relates to a waste disposal apparatus and methods.

This invention has particular application to waste disposal apparatus and methods suitable for use in marine sewage disposal applications, and for illustrative purposes the invention will be described hereinafter with reference to this application. However, it will be understood that the principles of this invention may find use in other applications such as remote site waste treatment and for treatment of waste streams other than sewage.

In the recreational and commercial operation of small ships, considerable waste is generated, which must be disposed of on shore or at sea. Of this disposal, the most sensitive issue is the one of disposal of raw sewage by direct pumping at sea. In some sites there are provided pump out facilities for holding chambers. However, these are far from widespread, and in many popular waterways raw sewage is simply pumped overboard with at most maceration.

Regulatory authorities have an environmental mandate that makes regulation of marine waste disposal easily acceptable by the majority non-boating public. In most areas there are now reasonable and mandatory clearances from sensitive area such as oyster leases and the like. Research indicates that coliform contamination from small craft is not an issue in all but the most sensitive and enclosed waterways, and that the volume of small craft effluent is insignificant relative to the volumes of primary and secondary-treated effluent from urban sources and untreated stormwater run-off. However, there is considerable pressure to introduce regulations that control the disposal of small craft effluent, as evidenced by the issue being on the agenda of the Small Craft Council in Queensland for several years, as a consequence of calls for submissions by the Queensland Government.

European Patent Publication No. 0 608 200 A1 describes a method and apparatus for treating black and grey water waste streams in brine or seawater using a tin dioxide anode in electrolysis to form hypochlorite and oxygenated species, passing the treated waste to a holding chamber and discharging the waste after a holding period sufficient to reduce the biological oxygen demand (BOD) and suspended solids of the waste by at least 30%. It is claimed that the use of the SnO₂ electrode causes an unexpected favouring of generation of bioactive oxygenated species at the expense of hypochlorite generation, resulting in 30% less residual chlorine in the discharged waste.

The described apparatus has several disadvantages when applied to the problems of waste management on small craft, trains or the like. The system requires pumping of the waste mixture between closely spaced electrodes, large overvoltages, pumping of the treated waste to a holding chamber and active mixing of the waste prior to admission to the electrolysis unit. The apparatus is a fixed installation and is not adapted for transport use where motion is expected.

### SUMMARY OF THE INVENTION

In one aspect the present invention resides broadly in waste water treatment apparatus including an electrolysis chamber adjacent a holding chamber, a waste inlet to said electrolysis chamber, a halide salt supply to said electrolysis chamber, at least one pair of electrodes disposed in said electrolysis chamber, at least the anodes of said electrodes being oriented whereby evolved gases at said anode promote a vertical circulation of waste in said electrolysis chamber, electrical supply means for said electrodes, a conduit having an inlet adjacent the bottom of said electrolysis chamber and an outlet to said holding chamber at a selected level of said electrolysis chamber, and discharge means associated with said holding chamber.

In a further aspect this invention resides broadly in a waste water treatment method including the steps of:

supplying waste in the form of a water effluent to an electrolysis chamber having at least one pair of electrodes, at least the anodes of said electrodes being oriented whereby evolved gases at said anode promote a vertical circulation of said waste in said electrolysis chamber;

supplying a halide salt to said electrolysis chamber to form a halide salt solution in said waste;

electrolysing said halide salt solution to hypohalite;

displacing said electrolysed solution into a holding chamber via a conduit having an inlet adjacent the bottom of said electrolysis chamber and an outlet to said holding chamber at a selected level of said electrolysis chamber;

holding said displaced waste in said holding tank for a biocidally effective holding time to form a treated waste; and

discharging said treated waste.

The waste may comprise any generally putrescent waste including food waste, sewage or the like. The waste may be comminuted, macerated or otherwise reduced as the waste allows. The waste is preferably formed into the effluent by admixture with an aqueous medium. The aqueous medium may itself comprise a waste stream, process water, fresh water or salt water. The electrolysis chamber and the holding chamber are preferably formed integrally of a plastics material or other like material resistant to attack by the effluent or electrolysis products.

The electrolysis chamber may take any suitable form. The inlet to the electrolysis chamber may deliver waste under pressure whereby the electrolysis chamber may be sealed and pressurized. A pressurized electrolysis chamber may be provided with pressure relief means which may vent directly to the exterior of the tank or may vent to the holding chamber. The electrolysis chamber may have a sloping floor to concentrate settled solids. For example, the floor may slope from one wall portion down to an opposite wall portion adjacent the inlet to the conduit, whereby solids progressively pass to the holding chamber in the effluent flow.

The electrolysis chamber may comprise level control means. The level control means may take any suitable form including a gravity displacement outlet to the holding chamber formed by the conduit, a level sensor associate with pump means or the like. The inlet may be provided with non return valve means.

The halide salt supply may comprise the aqueous effluent medium such as seawater in marine toilet outflows, or in the alternative may comprise dosing means adapted to supply solid or dissolved halide salt to the electrolysis chamber.

The electrolysis may be provided by the application of a voltage between two substantially inert electrodes suspended in the effluent in the holding chamber. In view of the generation of gaseous species the holding chamber is preferably vented. The electrodes may comprise differentially configured anode and cathode. However, in order to reduce or at least evenly spread calcium buildup on the electrodes, the polarity of the DC supply is preferably reversed on a periodic basis. Accordingly it is preferred that the electrodes be substantially identical. In view of the aggressive chemical environment, the electrode material is preferably selected to resist corrosion whilst resisting passivation in electrolysis. For example, the electrodes may be formed of base metal plated with platinum and/or platinum blacked, or may be of titanium or stainless steel of at least 316L grade. Preferably, at least the anodes and more preferably both electrodes comprise titanium or other valve metal electrode bodies having an active coating such as mixed ruthenium/iridium oxides, tin dioxide/antimony dioxide or the like. At least the anodes are preferably coated electrodes.

The electrodes are configured whereby the chlorine and other gases formed induce vertical circulation in the effluent. The circulation provides for even charging of the effluent with the treating hypohalite. Also, by this means, the fully charged countercurrent may advantageously be directed to pass the preferred displacement tube opening at the bottom of the electrolysis chamber, thereby ensuring that fully charged effluent is displaced over to the holding chamber. For example, the anode or both electrodes may be located at a spacing from the wall of the electrolysis chamber remote from a wall portion adjacent the conduit whereby circulation is up past the major surfaces of the anode, over the top of the waste and down the wall portion to pass the conduit inlet. Alternatively, the anode or both electrodes may be mounted from the top wall of the electrolysis chamber. The electrodes are disposed generally vertically to encourage vertical column circulation in the electrolysis chamber by virtue of the action of outgassed electrolysis products. The electrolysis chamber and/or holding chamber may be provided with further mechanical agitation to encourage homogeneous treatment. The mechanical stirring may be continuous, programmed by control means, or selective.

The holding chamber may take any suitable form. The holding chamber may be supplied with the treated effluent in the manner described in respect of displacement discharge or pumping from the electrolysis chamber. Preferably, a displacement tube extends from the bottom of the electrolysis chamber to an overflow outlet opening to the holding chamber. The overflow outlet may be provided with non-return means. The holding chamber may be pressurized and/or vented as per the electrolysis chamber.

The holding time for effluent in the holding chamber is determined by the selected microbial activity to be achieved and the choice and amount of the generated hypohalite. The holding chamber may be optionally cascaded with one or more subsequent holding chambers. If desired the holding chambers may be supplemented with additional antimicrobial material.

The electrolysis chamber and holding chamber may be integrally formed of fibre reinforced plastics material such as epoxy laminate, wherein a housing is divided into a treatment portion and a holding portion by a bulkhead. Alternatively, the electrolysis chamber and holding chamber may be formed as individual tanks, wherein a side wall of the electrolysis tank may be adjoined to a side wall of the holding tank. The side walls may be adjoined by any suitable methods such as welding or bonding. This embodiment may be similarly made of fibre reinforced plastics material such as epoxy laminate. In this embodiment, the adjoined walls act in the same manner as the bulkhead.

The transfer between the two is by displacement through the conduit; the bulkhead may simply extend from the common bottom of the housing to terminate below a common closure, with the outlet from the conduit being below the upper edge of the bulkhead, providing a common headspace. However, since in transport applications there may be considerable surge, the holding chamber may be substantially closed off from electrolysis chamber whereby the conduit extends from the bottom of the electrolysis chamber to an overflow outlet opening to the holding portion. The overflow outlet may be provided with non-return means.

The outlet for treated and held over effluent from the holding portion may be provided by displacement or by pumping. The pumping may be initiated by level monitoring means, may be selectively operable or both. Preferably, the control over pumping includes a cycle override control whereby pumping may be selectively discriminated against to ensure that pumping does not occur during passage of a vehicle carrying the apparatus through a region where discharge would be inappropriate.

The method and apparatus may be optimized for marine sewage disposal. In one embodiment, the apparatus is configured to accept waste from a marine toilet. In most cases the marine toilet entrains human waste with sea water which forms a ready supply of chlorine by available by electrolysis. Since caustic soda is a byproduct, and since the chlorine gas and caustic soda in part recombine to form persistent hypochlorite, the electrolytic process is has advantage over direct treatment with chlorine gas alone. The presence of caustic soda also encourages the breakdown of fatty components of the waste, thus reducing buildup of deposits in the tanks, plumbing and on the electrodes.

The marine toilet is preferably a manual or electric macerating toilet. The toilet may discharge directly to the electrolysis chamber for electrolytic treatment. The electrolytic treatment may be continuous or intermittent. It has been found that an initial run of about an hour at startup and about 5 minutes an hour for maintenance for an 80 L system served at 18 VA. The electrode pairs are preferably arranged in series whereby a voltage drop of 3-4 volts is maintained across each set of electrodes in a 12 volt system. In the marine examples, the inlets and outlets may be provided with non return means to withstand surge of the contents with vessel roll and pitch. The tank venting may be led outboard. The treatment and holding chamber portions may be integrally formed into the hull of a steel or glass reinforced plastic (GRP) vessel in like material.

In another aspect, this invention resides waste water treatment apparatus including:

an electrolysis chamber adjacent a holding chamber,

a water inlet to said electrolysis chamber,

a halide salt supply to said electrolysis chamber,

at least one pair of electrodes disposed in said electrolysis chamber,

electrical supply means for said electrodes,

an outlet from said electrolysis chamber to said holding chamber associated with a waste inlet to said holding chamber, and

discharge means associated with said holding chamber.

In a further aspect this invention resides in a waste water treatment method including the steps of:

supplying water to an electrolysis chamber having at least one pair of electrodes,

supplying a halide salt to said electrolysis chamber to form a halide salt solution in said water;

electrolysing said halide salt solution to hypohalite;

displacing said electrolysed solution through an outlet into a holding chamber in association with suppling waste to the holding chamber through an inlet;

holding said displaced waste in said holding tank for a biocidally effective holding time to form a treated waste; and

discharging said treated waste.

This waste treatment apparatus and waste treatment method may be suitably employed in trains and other public transport vehicles. Presently, waste from trains is dropped onto the railway tracks without any treatment. The present alternative waste treatment apparatus and method provides an on-site hypohalite generator, whereby a portion of the electrolysed hypohalite solution may be mixed with the waste contents of a toilet flush or at a selected toilet flush interval into a holding tank to be discharged by the operator at a selected interval.

Suitably the waste may be macerated and may include any waste as described above. The electrolysis chamber generates a hypohalite solution, preferably a hypochlorite solution. Suitably, the halide salt may be supplied in an amount to saturate the solution in the electrolysis chamber to about a 26% mix. The electrolysis chamber, the electrodes and electrolysis mechanism may be similar to that described above, though no waste is mixed into the electrolysis chamber. The halide salt may be more suitably provided in solid form rather than as seawater which is easily accessible in a marine environment, but not with in relation to land vehicles.

The holding chamber essentially functions as described above, with the difference that a portion of the electrolysed hypohalite solution may be associated with the supply of waste to the holding chamber. For example, the supply of hypohalite solution may be linked to the supply of waste to the holding chamber substantially concurrently with each toilet flush or other waste input or within a regulated number of toilet flushes or other waste input or at a waste level in the holding chamber that will allow for efficient biocidally sanitation.

The overall manufacture of the electrolysis chamber and holding chamber, the various conduits, inlets or outlets are also similarly described above.

### BRIEF DESCRIPTION OF THE DRAWINGS

The invention will be further described with reference to embodiments of the invention illustrated in the drawings, wherein:

FIG. 1 is a functional diagram of apparatus in accordance with the present invention;

FIG. 2 is a functional diagram of waste treatment alternative apparatus in accordance with the present invention;

FIG. 3 is a centreline cutaway right rear view of the alternative apparatus depicted in FIG. 2;

FIG. 4 is an isometric view of the alternative apparatus depicted in FIGS. 2 and 3;

FIG. 5 depicts the method of coliform enumeration performed by membrane filtration, and

FIG. 6 illustrates the rate of reduction of E. coli in the waste treatment apparatus of the invention.

### DETAILED DESCRIPTION OF THE INVENTION

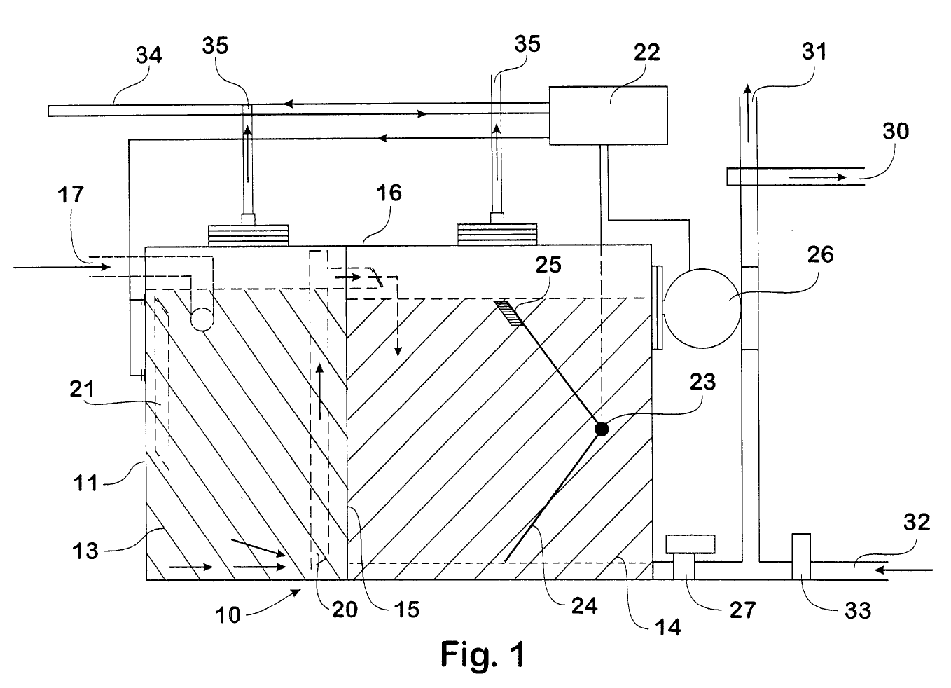

Referring to FIG. 1, there is provided waste treatment apparatus generally indicated as 10 and comprising a moulded plastic tank portion 11 forming an electrolysis chamber 13 and a holding chamber 14 separated by a bulkhead 15. The tanks 13 and 14 are mutually closed at their tops by tank top 16 which closes over the bulkhead 15 to form substantially isolated spaces in the respective tanks 13 and 14.

The electrolysis chamber 13 receives waste entrained in sea water from a macerating marine toilet (not shown) via a waste inlet 17 disposed at the upper portion of the electrolysis chamber 13. A displacement tube 20 picks up waste from the bottom of the electrolysis chamber 13 and discharges to the top of the holding chamber 14.

Mounted to the side wall of the electrolysis chamber 13 opposite the displacement tube 20 is a series of ruthenium/iridium oxide coated titanium electrode pairs 21. The electrodes 21 are disposed generally vertically to encourage vertical column circulation in the electrolysis chamber 13 by virtue of the action of outgassed electrolysis products. The electrode pairs 21 are supplied with current at about 3.5V under the control of controller 22.

The holding chamber 14 is provided with a suspended-weight mounted float transducer 23 located by a tie-down 24 and operated by level-responsive float 25. The float transducer 23 provides a signal representing holding chamber level data to the controller 22. The controller 22 controls the operation of a discharge pump 26 adapted to selectively empty the holding chamber 14 via valve 27 to sea via outlet 30 or to pump-out facility via outlet 31. The system may be flushed via raw water inlet 32 and valve 33.

The controller 22 switches the pump 26 to discharge selectively via control circuit 34 to the bridge, or automatically in response to a selected level being attained in the holding chamber 14. The control circuit 34 also enables the system to be actively discriminated against pumping to discharge when the vessel is in port or passing areas of sensitivity to discharge. The system is vented outboard for safety via breathers 35.

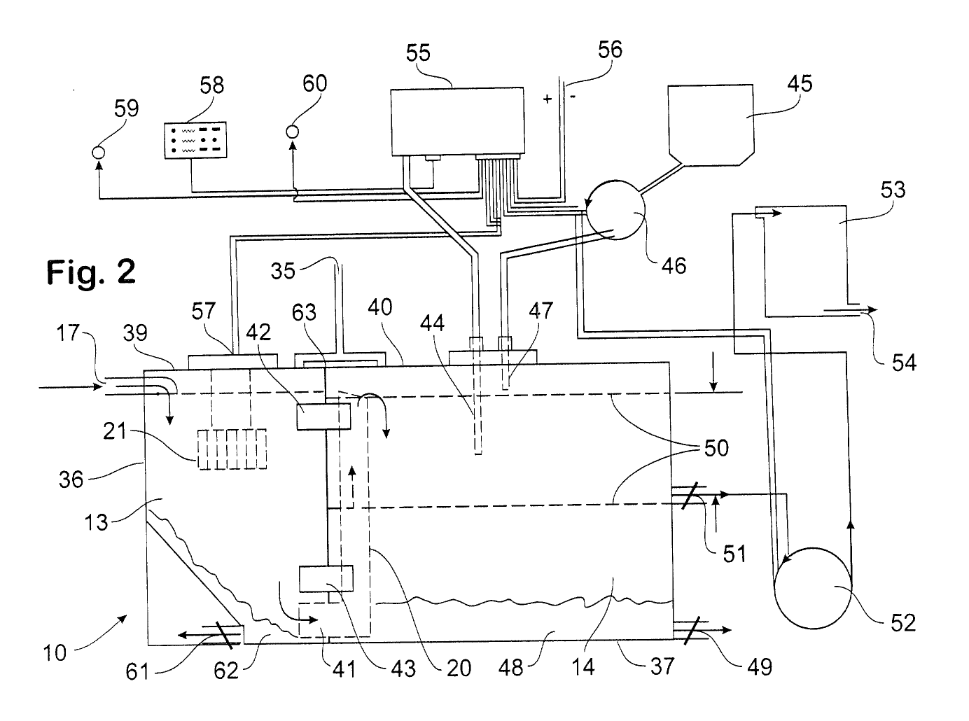

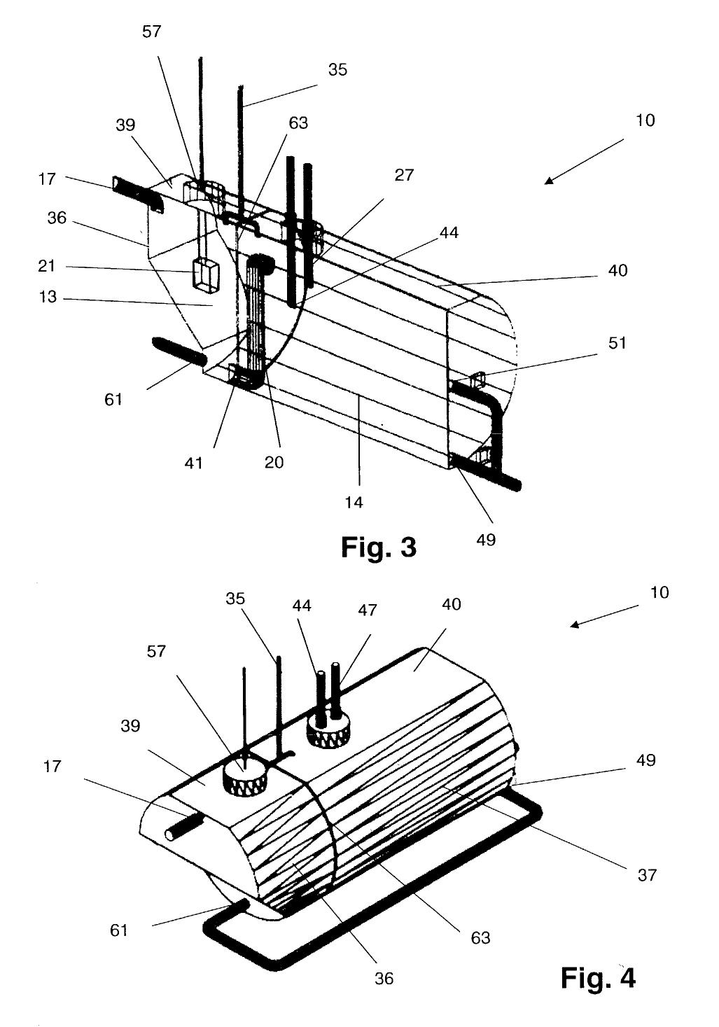

FIGS. 2 to 4 illustrate a second embodiment of the waste treatment apparatus 10 in accordance with the present invention comprising an electrolysis tank 36 forming an electrolysing chamber 13 and holding tank 37 forming a holding chamber 14 whereby adjoining walls 63 of tanks 36 and 37 are welded or bonded together. The adjoining walls 63 may be additional maintained together by welded straps 42 and 43. The chambers 13 and 14 are closed at their topes by tank tops 39 and 40 respectively.

The arrows depict the flow of waste material through the apparatus 10. The electrolysis chamber 13 receives waste entrained with sea water similar to the first embodiment via waste inlet 17 disposed at the upper portion of the electrolysis chamber 13. The electrolysis chamber 13 has a sloping floor to concentrate settled solids in lower floor region 62. The floor slopes from one wall portion to an opposite wall portion adjacent to the inlet 17 to an inlet 41 of a displacement tube 20 which displaces waste from the bottom 62 of the electrolysis chamber 13 to the top of the holding chamber 14. This displacement tube 20 differs from the first embodiment in that it is substantially positioned within the holding chamber. The level of waste in the electrolysis chamber 13 is maintained at a substantially full level, such that when waste is received via waste inlet 17 waste from the bottom 22 of the electrolysis chamber is automatically displaced into the inlet 41 discharging waste into the holding chamber 14.

Mounted to the tank top 39 of the electrolysis chamber 13 is a series of electrode pairs 21 as described above forming a cell. The electrode pairs 21 are generally disposed vertically in the electrolysis chamber 13 similar to the first embodiment to encourage vertical column circulation in the electrolysis chamber 13.

The second embodiment differs from the first embodiment in that a height pressure sensor 44 replaces the float system. The height pressure sensor 44 relays data to an electronic controller 55 which controls the operation of apparatus 10 which is described in more detail below.

The second embodiment waste treatment apparatus 10 also includes an optional polymer flocculation system to assist in settling the solids to the bottom 48 of the holding tank 14. Suitable polymer flocculants that are known in the art are held in a polymer container 45. When the level of electrolysed wastes reaches a detected level by the height pressure sensor 44, the flocculant polymers are discharged by peristaltic pump 46 through a polymer dosing inlet 47 into the holding container 14. The flocculant polymers cause the solids in the waste material to settle to the bottom 48 of the holding tank 37. When the solids reach a certain level or when the marine vessel is docked, the solids can be filtered through a bag of appropriate mesh size through a outlet 49 positioned in a lower portion of the holding chamber 14 through a valve, preferably a ball valve, assisted by a discharge pump 52.

When the liquid wastes located in the middle to upper portions 50 of the holding chamber 14 reach a certain level as detected by the height pressure sensor 44, the electrolysed liquid is discharged with the assistance of a discharge pump 52 through an outlet 51 via ball valve to a disposable filter bag 53. The disposable filter bag 53 may have an appropriate mesh size to ensure the capture of any significant mass of solid waste material. Suitably, the mesh size may vary in micron size to collect a regulated amount of suspended solids. Any sanitised waste liquids that pass through the filter bag 53 may be discharged through the outlet 54 to the sea or a pump out facility.

The electrolysis chamber 13 and holding chamber 14 are vented to the atmosphere for safety via a dual connecting hydrogen vent 35. The electrolysis chamber 13 and the holding chamber 14 may be flushed with raw water or sea water via inlets 17 and 41 and discharged via outlets and valves 61 and 49 with the assistance of the discharge pump 52.

As mentioned above, the waste treatment apparatus 10 is controlled by an electronic controller 55 powered by a 12 or 24 volt system 56, such as a battery. The controller 55 registers information from various components of the waste treatment apparatus 10, such as height pressure sensor 44, the ignition 59 and the toilet flush 60 to enable the efficient operation of the waste treatment apparatus 10 of the invention with little input from an operator. For example, upon receiving information that the ignition 59 of a marine vessel has been started, the electronics reminds the operator of the vessel to switch on the waste treatment apparatus 10.

The height pressure sensor 44 plays a significant role with respect to the controlling the operation of many components of the apparatus 10. The controlled 55 switches the pump 52 to discharge selectively by an operator via the display and switching panel 58 or automatically in response to a selected level being detecting in the holding chamber 14 by the height pressure sensor 14. At a selected level of waste in the holding chamber 20 detected by the height pressure sensor 44, then the controller 55 may activate the peristaltic pump 46 to discharge flocculation polymers from the polymer container 45 to holding chamber 14 via the polymer dosing inlet 47.

The controller 55 may also register the toilet flushes. However, more importantly the height pressure sensor 44 may indicate to the controller that the holding chamber 14 is full, but waste may not have undergone sufficient sanitation time to safely treat the sewerage before discharge or maybe the controller has been switched to manual control whereby automatic discharge is not possible. In response, the controller 55 may then disengage the toilet flush 60 to prevent surplus waste in the apparatus 10.

The display and switching panel 58 provides information to the operator to enable them to determine what actions are currently proceeding in the waste treatment apparatus 10. This may be indicated by a series of different coloured coded lights displayed on the display and switching panel 58. The display and switching panel 58 may also enable the operator to override to control the automated activities of the apparatus 10. This may be appropriate when the vessel is in port or passing areas sensitive to damage.

The following examples describe the results of the treatment of sewerage in the waste treatment apparatus 10 of the invention in order to illustrate the improved sanitising efficiency.

### EXAMPLE 1

Treatment consisted of running the electronic system for 4 hours prior to the addition of the challenge microorganism Escherichia coli. After addition of the challenge inoculum, the system was allowed to operate for a further 2 hours before a recovery sample was taken into neutraliser broth containing sodium thiosulphate.

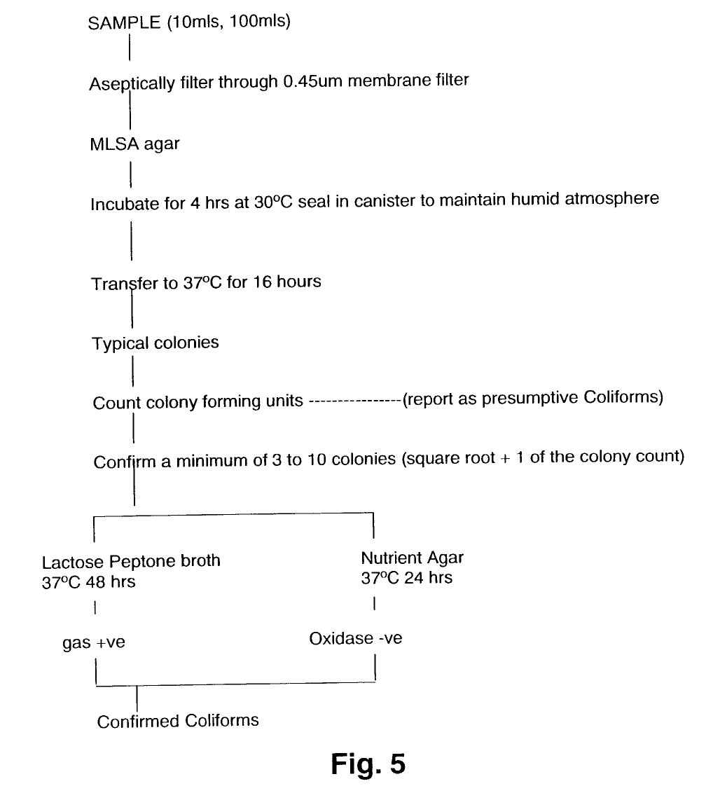

Testing was performed by membrane filtration method shown in FIG. 5: Typical colonies appear as yellow small domed colonies with an entire edge. (See 3-3-2-graphic). The usual convention is to report water test results as x number of coliforms per 100 ml. The coliforms are reported as (actual count)cfu/100 ml. If no coliforms were detected it is reported as 0 cfu/100 ml. This also applies to the following Examples.

The pre-treatment count was taken immediately after addition of the E. coli and mixing had taken place. The results are indicated in Table 1.

TABLE 1

| EML S/N | Pre treatment count of | Post treatment count of |
|---|---|---|
| 14288 | E. coli/100 ml | E. coil/100 ml |
| Supplied sea | <1 | <1 |
| water. Control | | |
| Supplied sea | 26,000 | <1 |
| water + E. coli | | |
| inoculum | | |

This represents a 99.99999% reduction in bacteria numbers from the initial challenge load.

### EXAMPLE 2

Treatment consisted of running the electronic system for 4 hours prior to the addition of the challenge microorganism Escherichia coli. After addition of the challenge inoculum, the system was allowed to operate for a further 2 hours before a recovery sample was taken into neutraliser broth containing sodium thiosulphate. Testing was performed by membrane filtration method shown in FIG. 5.

The pre-treatment count was taken immediately after addition of the E. coli and mixing had taken place. The test results are indicated in Table 2.

TABLE 2

| | | Final E. coli | | Total |
|---|---|---|---|---|
| | Initial E. coli | count | | suspended |
| Test series no. | count Cfu/100 ml | Cfu/100 ml | Comment | solids |
| Series 1a | 56,000,000 | <10 | No soil, No Flocculent | |
| Series 1b | 116,000,000 | <10 | No soil, No flocculent | |
| Series 1c | 7,200,000 | <10 | No soil, No flocculent | |
| Series 1d | 350,000,000 | <10 | No soil, No flocculent | |
| Series 1e | 108,000,000 | <10 | No soil, No flocculent | |
| Series 2a | 96,000,000 | <10 | IL Soil, No flocculent | |
| Series 2b | 110,000,000 | <10 | IL Soil, No flocculent | |
| Series 2c | 1 ,000,000 | <10 | IL Soil, No flocculent | |
| Series 2d | 50,000,000 | <10 | IL Soil, No flocculent | |
| Series 2e | 158,000,000 | <10 | IL Soil, No flocculent | |
| Series 3a | 330,000,000 | <10 | IL Soil, flocculent A | 60 |
| Series 3b | 10,000,000 | <10 | IL Soil, flocculent A | 120 |
| Series 3c | 66,000,000 | <10 | IL Soil, flocculent A | 300 |
| Series 3d | 840,000 | <10 | IL Soil, flocculent B | 14 |
| Series 3e | 19,000,000 | <10 | IL Soil, flocculent B | 10 |
| Series 3f | 84,000,000 | <10 | IL Soil, flocculent B | <10 |

### EXAMPLE 3

Treatment consisted of running the electronic system for 4 hours prior to the addition of the challenge microorganism Escherichia coli. After addition of the challenge inoculum, the system was sampled at 15 minute intervals thereafter. Samples were taken into neutraliser broth containing sodium thiosulphate. Testing was performed by membrane filtration method shown in FIG. 5.

The pre-treatment count was taken immediately after addition of the E. coli and mixing had taken place. The results are shown in Table 3.

TABLE 3

| | | E. coil count | |
|---|---|---|---|
| Time | Action | Cfu/100 ml | Comment |
| −4 hours | System | 0 | Sterilised sewage and seawater added to |
| | activated | chamber | |
| 0 hours | Challenge | 2,500,000 | |
| | bacteria added | | |
| 0 hrs 15 mins | | 5,000 | 99.8% reduction |
| 0 hrs 30 mins | | 27 | 99.9989% reduction |
| 0 hrs 45 mins | | <1 | No E. coli noted >99.99996 reduction |
| 1 hr | | <1 | No E. coli noted >99.99996 reduction |
| 1 hr 15 mins | | <1 | No E. coli noted >99.99996 reduction |
| 1 hr 30 mins | | <1 | No E. coli noted >99.99996 reduction |
| 1 hr 45 mins | | <1 | No E. coli noted >99.99996 reduction |
| 2 hrs | | <1 | No E. coli noted >99.99996 reduction |
| 2 hrs 15 mins | | <1 | No E. coli noted >99.99996 reduction |
| 2 hrs 30 mins | | <1 | No E. coli noted >99.99996 reduction |
| 2 hrs 45 mins | | <1 | No E. coli noted >99.99996 reduction |
| 3 hrs | | <1 | No E. coit noted >99.99996 reduction |
| 3 hrs 15 mins | | <1 | No E. coli noted >99.99996 reduction |
| 3 hrs 30 mins | | <1 | No E. coli noted >99.99996 reduction |
| 3 hrs 45 mins | | <1 | No E. coli noted >99.99996 reduction |
| 4 hrs | | <1 | No E. col, noted >99.99996 reduction |
| 5 hrs | | <1 | No E. coli noted >99.99996 reduction |
| 6 hrs | | <1 | No E. coli noted >99.99996 reduction |
| 7 hrs | | <1 | No E. coli noted >99.99996 reduction |
| 8 hrs | | <1 | No E. coli noted >99.99996 reduction |

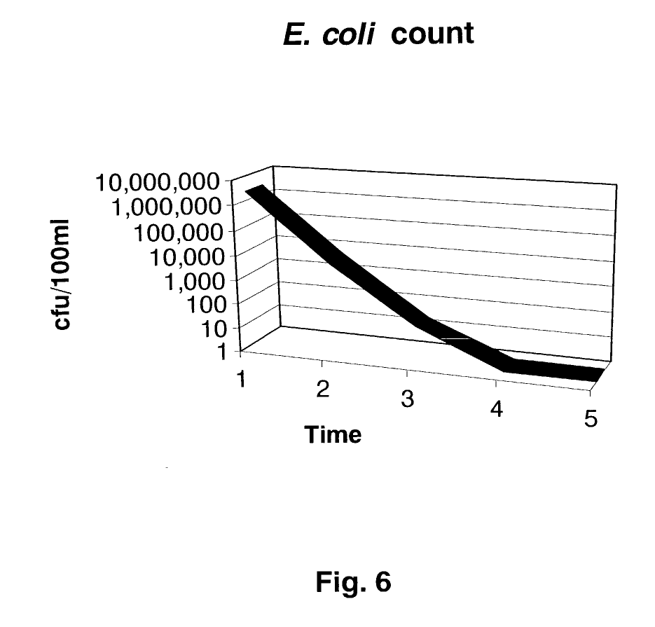

The graph illustrated in FIG. 6 details the rate of reduction over time visually. The horizontal axis represents time, with each unit equivalent to 15 minutes after addition of the inoculum culture.

It will of course be realised that while the above has been given by way of illustrative example of this invention, all such and other modifications and variations thereto as would be apparent to persons skilled in the art are deemed to fall within the broad scope and ambit of this invention as defined in the claims appended hereto.

1. Waste water treatment apparatus including an electrolysis chamber adjacent a holding chamber, a waste inlet to said electrolysis chamber, a halide salt supply to said electrolysis chamber, at least one pair of electrodes disposed in said electrolysis chamber, at least the anodes of said electrodes being oriented whereby evolved gases at said anode promote a vertical circulation of waste in said electrolysis chamber, electrical supply means for said electrodes, a conduit having an inlet adjacent the bottom of said electrolysis chamber and an outlet to said holding chamber at a selected level of said electrolysis chamber, and discharge means associated with said holding chamber.

2. Waste water treatment apparatus according to claim 1, wherein said electrolysis chamber and said holding chamber form an integral waste treatment tank.

3. Waste water treatment apparatus according to claim 1, wherein at least said anode of said electrodes is located adjacent a wall portion of said electrolysis chamber, said conduit being located at a wall portion of said electrolysis chamber remote from said anode.

4. Waste water treatment apparatus according to claim 3, wherein said electrodes may comprise identically configured anode and cathode.

5. Waste water treatment apparatus according to claim 4, wherein the polarity of said electrical supply is reversed on a periodic basis.

6. Waste water treatment apparatus according to claim 5, wherein said electrodes are selected from titanium or other valve metal electrode bodies having an active coating selected from mixed ruthenium/iridium oxides, tin dioxide/antimony dioxide or the like.

7. Waste water treatment apparatus according to claim 1, wherein the electrolysis chamber has a floor that slopes from one wall portion down to an opposite wall portion adjacent the inlet to the conduit, whereby solids progressively pass to the holding chamber in the effluent flow.

8. Waste water treatment apparatus according to claim 1, wherein said halide salt supply comprises the aqueous effluent medium of seawater of a marine toilet outflow comprising said waste.

9. Waste water treatment apparatus according to claim 1, wherein said holding chamber is provided with a suspended-weight mounted float transducer located by a tie-down and operated by level-responsive float, and wherein said float transducer provides a signal representing holding chamber level data to a controller that controls the operation of said discharge means.

10. Waste water treatment apparatus according to claim 9, wherein said discharge means is adapted to selectively empty the holding chamber.

11. Waste water treatment apparatus according to claim 10, wherein said controller switches a pump to discharge selectively via by instructions from an operator.

12. Waste water treatment apparatus according to claim 10, wherein said controller switches a pump to discharge automatically in response to a selected level being attained in the holding chamber.

13. Waste water treatment apparatus according to claim 1, wherein said electrolysis and holding chambers are integrally formed into the hull of a steel or GRP vessel in like material.

14. Waste water treatment apparatus according to claim 1, wherein a flocculant polymer is added to the holding tank.

15. Waste water treatment apparatus according to claim 14, wherein settled flocculated solids are selectively filtered through an outlet positioned in the bottom portion of the holding chamber.

16. Waste water treatment apparatus according to claim 1, wherein said electrolysis chamber and said holding chamber are separate tanks and a wall of the electrolysis tank is adjoined to a wall of the holding tank.

17. Waste water treatment apparatus according to claim 16, wherein said electrodes are mounted from the top wall of said electrolysis chamber, said conduit being located at a wall portion of said holding chamber.

18. Waste water treatment apparatus according to claim 17, wherein said electrodes may comprise identically configured anode and cathode.

19. Waste water treatment apparatus according to claim 18, wherein the polarity of said electrical supply is reversed on a periodic basis.

20. Waste water treatment apparatus according to claim 20, wherein said electrodes are selected from titanium or other valve metal electrode bodies having an active coating selected from mixed ruthenium/iridium oxides, tin dioxide/antimony dioxide or the like.

21. Waste water treatment apparatus according to claim 1, wherein said holding chamber is provided with a height pressure sensor that provides a signal representing holding chamber level data to a controller that controls the operation of said discharge means.

22. Waste water treatment apparatus according to claim 21, wherein said discharge means is adapted to selectively empty the holding chamber.

23. Waste water treatment apparatus according to claim 22, wherein said controller switches a pump to discharge selectively via an outlet by instructions from an operator.

24. Waste water treatment apparatus according to claim 22, wherein said controller switches a pump to discharge automatically in response to a selected level being attained in the holding chamber.

25. Waste water treatment apparatus according to claim 1, wherein electrolysed waste is discharged from the holding chamber through a filter bag to collect a regulated amount of suspended solids.

26. Waste water treatment apparatus according to claim 25, wherein the filtered waste is discharged to a marine environment or a pump-out facility.

27. Waste water treatment apparatus according to claim 1, wherein said electrolysis chamber and said holding chamber are vented to the atmosphere.

28. Waste water treatment apparatus according to claim 9, wherein said controller disengages the toilet flush receipt of a signal that the holding chamber is full.

29. Waste water treatment apparatus according to claim 21, wherein said controller disengages the toilet flush receipt of a signal that the holding chamber is full.

30. Waste water treatment apparatus according to claim 1, wherein a display panel indicates to an operator the current status of the said waste water treatment apparatus.

31. Waste water treatment apparatus according to claim 30, wherein said display panel enables the operator to override one or more of the activities in progress of said water treatment apparatus or to activate one or more activities of said waste water treatment apparatus.

32. Waste water treatment apparatus according to claim 1, wherein said waste water treatment apparatus includes a controller that controls the activity of said waste water treatment apparatus upon the receipt of requisite data from one or more components of said waste water treatment apparatus or upon receipt of instructions from an operator.

33. A waste water treatment method including the steps of:
supplying waste in the form of a water effluent to an electrolysis chamber having at least one pair of electrodes, at least the anodes of said electrodes being oriented whereby evolved gases at said anode promote a vertical circulation of said waste in said electrolysis chamber;
supplying a halide salt to said electrolysis chamber to form a halide salt solution in said waste;
electrolysing said halide salt solution to hypohalite;
displacing said electrolysed solution into a holding chamber via a conduit having an inlet adjacent the bottom of said electrolysis chamber and an outlet to said holding chamber at a selected level of said electrolysis chamber;
holding said displaced waste in said holding tank for a biocidally effective holding time to form a treated waste; and
discharging said treated waste.

34. A waste water treatment method according to claim 33 using a waste water treatment apparatus according to any one of claims 1 to 32.
